(19) United States
(12) Patent Application Publication
(10) Pub. No.: US 2001/0038871 A1
(43) Pub. Date: Nov. 8, 2001

(54) SELECTABLE AGENT DELIVERY SYSTEM

(75) Inventor: SALLY NARDI, SACO, ME (US)

Correspondence Address: CHRIS A CASEIRO, PIERCE ATWOOD, ONE MONUMENT SQUARE, PORTLAND, ME, 04101

(73) Assignee: SALLY NARDI

(21) Appl. No.: 09/309,634

(22) Filed: May 11, 1999

(51) Int. Cl. A23L 1/00

(52) U.S. Cl. 426/85; 426/86; 426/132; 426/134

(57) ABSTRACT

An agent-delivery system for dispensing active agents of choice into ingestible materials of choice. The agent-delivery system includes a component for retaining the agent, typically in an extract form, which component is directed by the user into contact with an ingestible material. The extract is preferably water-soluble so that it may be dissolved into a fluid, generally a beverage of choice. The agent-retaining component may be a straw, spoon, soluble film, cap interior, or other suitable substrate capable of holding the extract. The extract may be applied to the retaining component in any of a number of ways, including by ink-jet spray equipment, or hand brushing, for example. Barrier sealants may be used to isolate the extract from the beverage until such time as the user wishes to enhance the beverage through agent introduction.

### BACKGROUND OF THE INVENTION

1. Field of Invention

The present invention relates to the field of agent delivery systems. More particularly, the present invention relates to systems for transferring into a fluid of interest selectable quantities of one or more selectable agents. Still more particularly, the present invention relates to a plurality of delivery mechanisms whereby a user may select an agent of interest, in a quantity of interest, for ingestion through a medium of interest.

2. Description of the Prior Art

In recent years, the interest in the use of agents that are generally regarded as safe has grown significantly. Such agents include, but are not limited to, Echinacea, St. John's wort, ginseng, many vitamins, as well as others. While their usage increases, the impact of their popularity may be diminished by a problem that has existed for many years in regard to standard medicinal delivery systems. That is, the agent that is ultimately to be delivered is usually available in a medium that is less-than-desirable to ingest. Specifically, they come in tablets, gelcaps, or liquids of marginal, if not prohibitive, taste. This major failing of the delivery system likely alters to a significant extent the actual introduction of beneficial agents.

For children in particular, who tend to refuse, or at least make terribly difficult, the ingestion of agents designed to improve their well-being, the agent delivery task can be an arduous one—for parent and child alike. Offering the agent in a solution of some type that is of suitable taste to the child would likely result in an increase in useful agent ingestions. It should also be noted that adults, who while mentally recognizing the value of agent ingestion, may nevertheless reduce agent intake as a function of delivery system taste. It would be of great value to provide to children and adults the means to ingest agents of interest in quantities of interest under desirable conditions. Unfortunately, with the wide array of taste variations from one individual to another, it would be virtually impossible for a supplier of such agents to offer completely satisfactory delivery systems under suitable economic conditions.

It would therefore be desirable to have a delivery system that the individual user could customize. Specifically, it would be beneficial to allow each user to select the agent of interest in the quantity of interest to be ingested in the delivery system of interest. In that regard, it is the focus of the present invention to retain a fixed quantity of an agent of interest on some form of carrier material. When the user wishes to ingest the agent, he or she contacts the carrier material with a fluid or other substrate of interest, such as a favorite food, such that the agent is diluted therein. Somewhat related arrangements have been developed by others, although they have been observed to be of less-than-complete customization of the form contemplated by the present invention. Two prior-art systems of note are described herein.

U.S. Pat. No. 3,957,202 issued to Hornsby, Jr. describes a drinking straw having a coating of material on its exterior surface. As the user draws fluid into the straw, the material causes a change in the color of the straw. The idea focuses on sealing the material to the exterior surface such that it does not directly contact the fluid. Instead, the fluid temperature causes a change in the material's color. This patent does not specifically describe the usefulness of allowing the material coating the exterior of the straw to contact the fluid for the purpose of combining the two, particularly since the material is on the exterior.

U.S. Pat. No. 4,024,952 issued to Leitz discloses a container cap having a compartment for retaining material to be selectably dispensed into the container. When the cap is opened, the material is released into the container. Unfortunately, the Leitz device is a complex one requiring specific mechanical operations, thereby rendering it less than economically suitable for large-scale fabrication. In addition, a complex system is less likely to be of interest for use by many, and children in particular, when the goal is to increase the ease-of-use and thereby the introduction of desirable agents in desirable ingestion media. It also appears that the Leitz system does not allow for the introduction of multiple packets of one or more agents of interest into the fluid of interest. Importantly, the Leitz system is described as including a releasable bottom component that may well be capable of falling into the container's contents. As a result, that component may well pose a significant choking hazard. Finally, Leitz does not allow for the introduction of agents into existing containers having standard off-the-shelf caps.

Therefore, what is needed is an agent delivery system that permits the introduction of one or more agents of interest in quantities of interest into any ingestible medium of interest, including but not limited to liquid drinks. What is also needed is such a system that may be readily adapted to existing fluid containers. Further, what is needed is such a system that is relatively inexpensive to produce and apply such that its impact on the cost of the agents and the ingestion media are minimal.

### SUMMARY OF THE INVENTION

It is an object of the present invention to provide an agent delivery system that permits the introduction of one or more agents of interest in quantities of interest into any ingestible medium of interest, including but not limited to liquid drinks. It is also an object of the present invention to provide such a system that may be readily adapted to existing fluid containers. Yet further, it is an object of the present invention to provide such an agent delivery system that is relatively inexpensive to produce and apply such that its impact on the cost of the agents and the ingestion media are minimal.

These and other objects are achieved through the agent delivery system of the present invention. The delivery system designed to enable the delivery of controlled dosages of agents that are generally regarded as safe. These agents include, but are not limited to, extracts of herbs and botanicals. The agents are preferably in a fluid form, such as in an extract, or they may be in some sort of powder form. The delivery system permits a user to ingest selectively a quantity of the agent through a selectable medium—generally a liquid drink. Specifically, the user can selectively dispense predetermined amounts of one or more fluid-soluble active substances, preferably extracted from natural materials (e.g., vitamins, minerals, botanicals, or blends thereof into hot or cold beverages. The user may thereby easily convert an existing beverage into an enhanced beverage by allowing the extract to come into contact with the liquid, thus releasing the active substance into solution.

The delivery substrate can come in a variety of forms including, but not limited to, a straw having the agent detachably affixed to the interior of the straw, a fluid cap having the agent detachably affixed to its interior surface, a utensil such as a spoon having the agent applied thereto, or the exterior surface of a container to which a removable impregnable pouch containing the agent is affixed. A vapor barrier may be used to seal the agent from interior contents or exterior surface of the container prior to selective dispersion in the container's fluid. Alternatively, the agent may be affixed to the interior of a straw, cap, etc., by any number of methods, such as by spraying an extract, by direct application of the extract, or by detachably adhering the agent in a powder form. It is important to note that the invention is directed to application of a desirable agent to a substrate of the type that regularly comes in contact with substances that people ingest-preferably fluids. As such, and in addition, carriers as simple as agent-containing sugar, honey, or any other medium consumers tend to place into beverages, etc., of choice, may be employed.

The advantage in the invention is that a user can select the type of substance-juice, water, milk, applesauce, etc. that he/she would like to ingest while at the same time ingesting the health-enhancing agent. For example, a child can be given his or her favorite beverage. The child can use an agent-coated straw to drink the juice such that the agent will dissolve in the juice and drawn in by the child. Alternatively, the child may open a water bottle having an agent-coated cap. Upon removal of the vapor barrier the water will contact the agent and the agent will become dissolved therein. The invention thereby lends itself to selectability of the particular agent that one can ingest as well as the quantity of that agent (such as by using a plurality of coated straws) to be ingested.

It is to be understood that other objects and advantages of the present invention will be made apparent by the following description of the drawings according to the present invention. While a preferred embodiment is disclosed, this is not intended to be limiting. Rather, the principles set forth herein are illustrative of the scope of the present invention and it is to be understood that changes may be made without straying from the scope of the invention.

### BRIEF DESCRIPTION OF THE DRAWINGS

FIG. 1 is a side view of the first preferred embodiment of the agent delivery system of the present invention, showing an agent-retaining straw.

FIG. 2A is a perspective view of the second preferred embodiment of the agent delivery system of the present invention, showing an agent-retaining cap.

FIG. 2B is a cross-sectional side view of the second preferred embodiment of the agent delivery system of the present invention, showing the agent-retaining cap of FIG. 2A.

FIG. 2C is a cross-sectional end view of the second preferred embodiment of the agent delivery system of the present invention, showing the agent-retaining cap of FIG. 2A.

FIG. 3A is a top view of the third preferred embodiment of the agent delivery system of the present invention, showing a soluble-film delivery device.

FIG. 3B is a side view of the third preferred embodiment of the agent delivery system of the present invention, showing the soluble-film delivery device of FIG. 3A as applied to the exterior of a container.

FIG. 4A is a cross-sectional side view of the fourth preferred embodiment of the agent delivery system of the present invention, showing an agent-retaining spoon.

FIG. 4B is a top view of the fourth preferred embodiment of the agent delivery system of the present invention, showing the agent-retaining spoon of FIG. 4A.

### DETAILED DESCRIPTION OF THE PREFERRED EMBODIMENTS

In general, the present invention includes an agent-retaining device for suitable storage of an agent of interest in a quantity of interest. The agent-retaining device may be a stand-alone unit that can be used to direct the agent into an ingestible medium, such as a fluid, of interest. Alternatively, the agent-retaining device may be coupled to a container ordinarily designed to retain ingestible media. The four embodiments described herein are exemplar representations of such an agent-retaining device and are not intended to limit the scope of the invention.

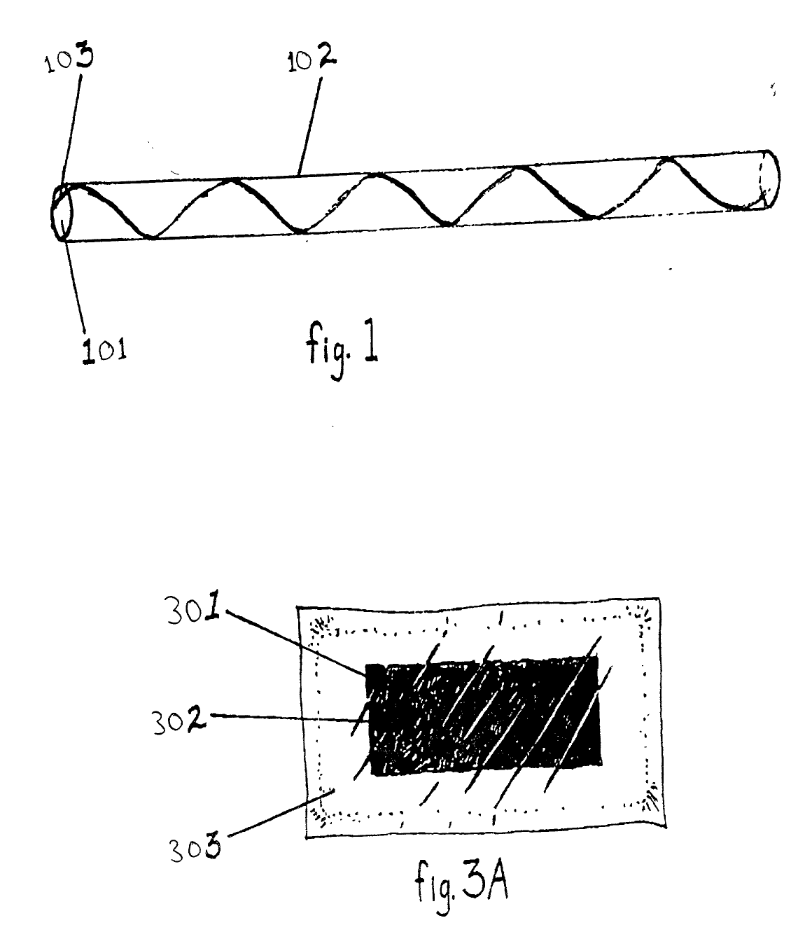

As illustrated in FIG. 1, a first embodiment of the agent-retaining device of the present invention is a straw 102 having an interior surface 101. The straw 102 is preferably clear so that its interior surface 101 can be viewed from the outside. A predetermined quantity of a water-soluble extract 103 is preferably sprayed onto the interior surface 101 of the straw 102 in a manner well known to those skilled in the art of spray-on applications. The extract 103 is formed to include an ingestible agent of choice, with the extract 103 diluted sufficiently to ensure that a repeatable defined amount of the agent will be ingested by a user when a fluid is transferred from a container through the straw 102 to the user until the extract 103 is dissolved and the interior 101 is clear. In this way, the user can select any straw independent of the particular fluid into which the extract 103 is to be dissolved such that an agent of choice may be imparted along with a fluid of choice.

The extract 103 is preferably created in a manner that ensures its viscosity is sufficient to allow it to pass through a plurality of spray nozzles similar to that required in the spray application by ink-jet coders. In that way, the extract 103 may be applied as a spiral line as shown in FIG. 1, or it may be applied as a series of writings, illustrations, or anything else of artistic or informational interest. In addition, it may be suitable to incorporate colorings, flavorings, or the like into the water-soluble extract 103 so as to provide visual or taste identification related to the particular agent to be ingested. The straw 102 may be individually wrapped as for one-time agent purchases, or it may come packed with a plurality of similarly treated straws. The existing technology for ink-jet systems makes this embodiment of the present invention immediately viable.

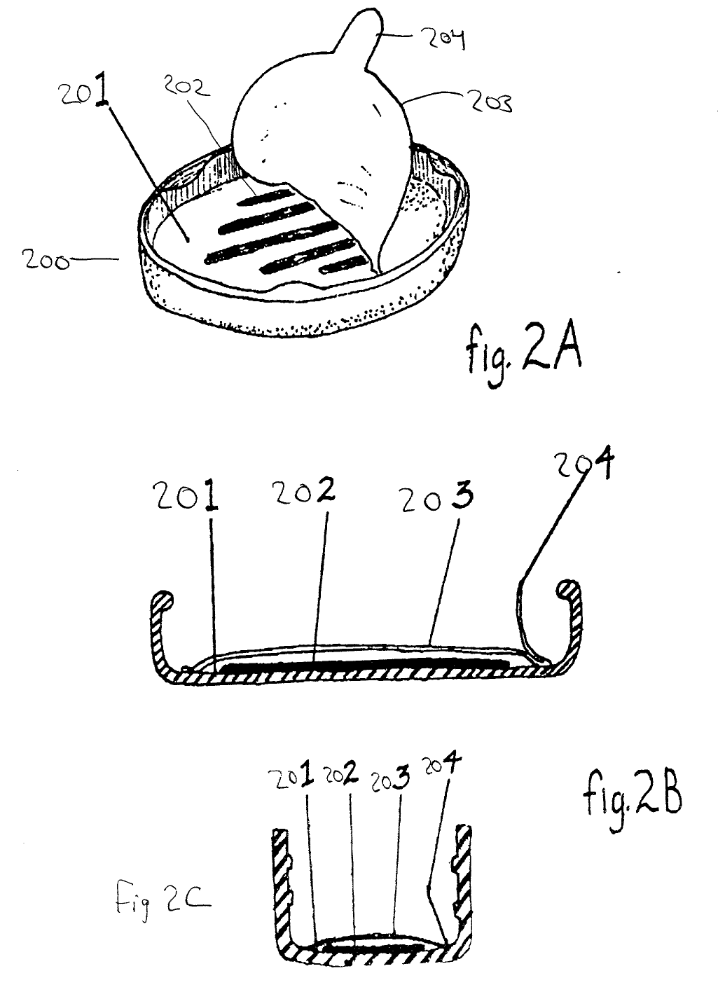

As illustrated in FIGS. 2A-2C, the second embodiment of the present invention is a cap 200 including an interior top surface 201 on to which an agent-containing extract 202 may be applied, as by spraying in the manner noted with respect to the straw 102. Alternatively, the extract 202 may be applied by dipping, machine brushing, hand brushing, or otherwise. After the extract 202 has been applied, an impervious film 203, preferably clear plastic, is placed over the interior surface 201 to encapsulate the extract 202. The film 203 acts as a moisture barrier, protecting the extract 202 from liquid contained within a container secured by the cap 200. A small tab 204 extending from the film 203 may be pulled so as to remove the film 203 and expose the extract 202. Once the cap 200 is replaced on the container, a simple shake of the closed container will expose the extract 202 to the fluid within the container, allowing the extract 202 and thereby the agent of interest, to go into solution for subsequent ingestion. Through this design the user has the option to ingest the agent when ready, whether immediately upon the opening of the cap 200, or subsequently after initial ingestion of unenhanced beverage.

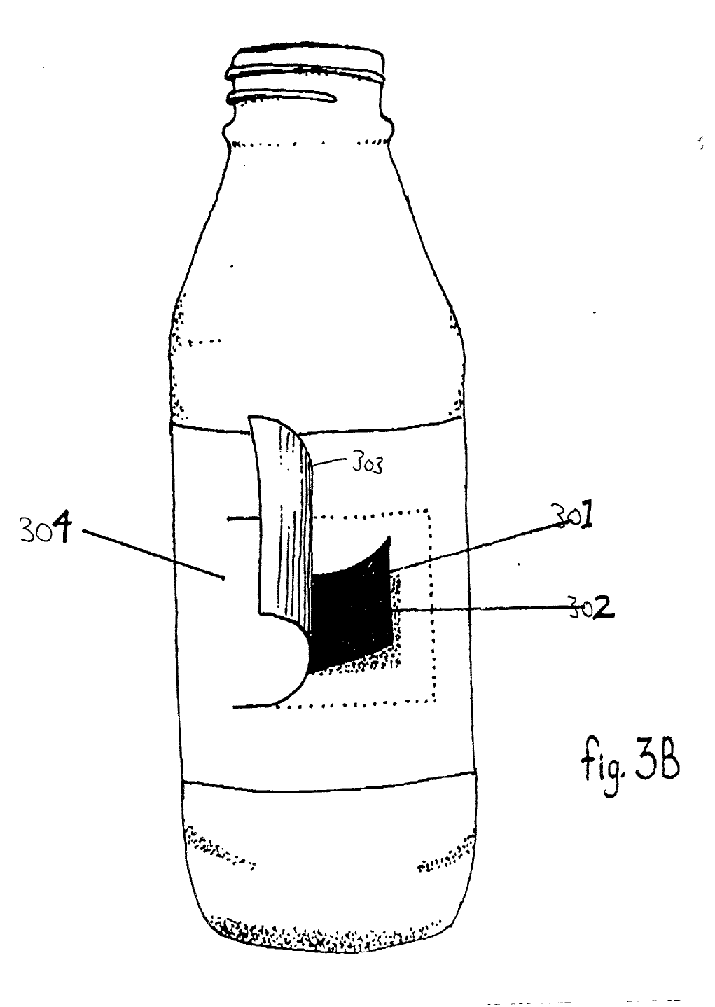

As illustrated in FIGS. 3A-3B, the third embodiment of the agent-delivery device of the present invention is a treated film 301. The film 301 is water-soluble and may be edible if desired. The film 301 is impregnated with an agent-containing extract 302 that has preferably been dried to a powder consistency. Alternatively, the extract 302 may be in fluid formed retained within a laminated version of the film 301. As with the other extracts previously described, the extract 302 may be colored and/or flavored as necessary or desired. The film 301 may be sized and shaped to conform to packaging and/or container-coupling limitations. When the user is ready to ingest the extract 302, he or she may simply add the film 301 to the fluid, thereby delivering the active agent into solution as the film 301, a dry, self-contained vehicle for the extract 302, dissolves. A plurality of pieces of the treated film 301 may be individually wrapped in protective packaging 303, substantially as shown in FIG. 3A. Alternatively, the treated film 301 may be sealed onto the surface of a container 304 as shown in FIG. 3B for use with the fluid contained within that container 304 to which the film 301 is applied and covered with the protective cover 303. Of course, other edible substrates, such as starch-based compounds, including, but not limited to, agent-treated edible glitter for example, may be employed as the agent carrier.

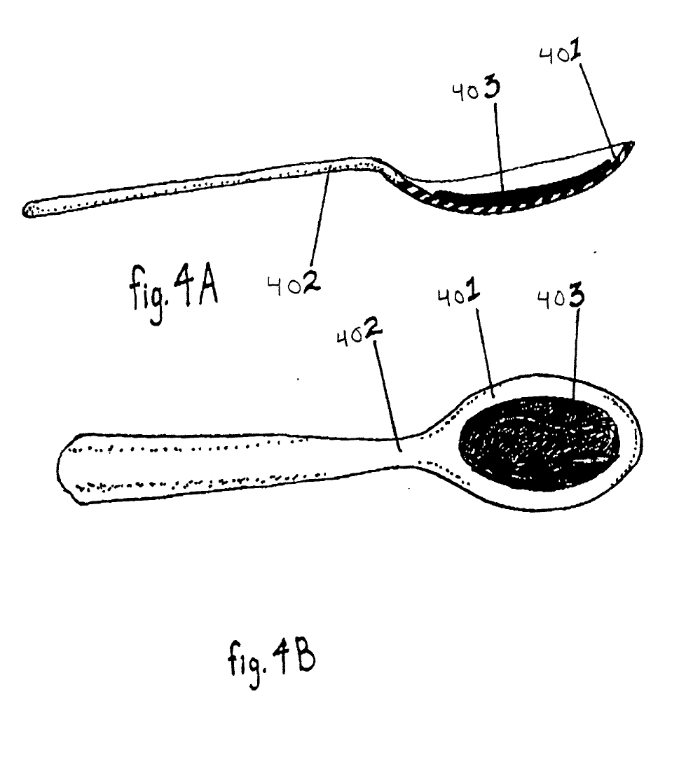

A fourth simple embodiment of the agent-containing device of the present invention is shown in FIGS. 4A-4B. In that version of the invention, a spoon 402 having a concave interior surface 401 is used to retain an agent-retaining extract 403 similar to the arrangement used in regard to the straw 102 of FIG. 1. Specifically, the surface 401 includes a predetermined quantity of an agent of choice retained in the water-soluble extract 403. The extract 403 may be applied in the manner earlier described with respect to the other embodiments of the invention. The spoon 402 may be used to stir any sort of beverage of interest and, once in contact with that beverage, the extract 403 containing the agent of choice will go into solution in the beverage of choice. The spoon 402 is preferably individually wrapped in a manner similar to that used in regard to the protective cover 303 for film 301.

It should be understood that the embodiment mentioned here are illustrative of the present invention. Numerous design modifications and variations in use of the invention may be contemplated in view of the following claims without straying from the intended scope of the invention herein disclosed.

What is claimed is:

1. An agent delivery system for the selectable introduction of one or more active agents into an ingestible medium of interest, the agent delivery system comprising:
a. an agent-retaining component for retaining the one or more active agents, wherein said agent-retaining component is designed to contact the ingestible medium of interest; and
b. a soluble extract including said one or more active agents and retainable by said agent-retaining component.

2. The system as claimed in claim 1 wherein said agent-retaining component is a straw having an interior surface to which said soluble extract is applied.

3. The system as claimed in claim 2 wherein said soluble extract is applied to said interior surface of said straw using an ink-jet spray applicator.

4. The system as claimed in claim 3 wherein said soluble extract is applied in a shape selected from the group consisting of designs and text.

5. The system as claimed in claim 2 wherein said soluble extract includes food coloring.

6. The system as claimed in claim 2 wherein said soluble extract includes inactive food flavoring.

7. The system as claimed in claim 1 wherein said agent-retaining component is a cap detachably affixable to a container, said cap having an interior surface to which said soluble extract is affixed.

8. The system as claimed in claim 7 further comprising a removable vapor barrier affixed to said interior surface of said cap, wherein said vapor barrier is applied over said soluble extract to prevent contact of said soluble extract with a fluid within the container until such contact is initiated by a user.

9. The system as claimed in claim 8 wherein said removable vapor barrier includes a tab for pulling said vapor barrier away from said interior surface of said cap.

10. The system as claimed in claim 1 wherein said agent-retaining component is a soluble film to which said soluble extract is applied.

11. The system as claimed in claim 10 further comprising a protective plastic package for isolating and sealing said soluble film therein.

12. The system as claimed in claim 11 wherein said protective plastic package includes means for affixing said plastic package to an exterior of a container.

13. The system as claimed in claim 10 wherein said soluble extract is in powder form.

14. The system as claimed in claim 1 wherein said agent-retaining component is a spoon having a concave interior surface to which said soluble extract is affixed.
